(19) United States
(12) Patent Application Publication
(10) Pub. No.: US 2011/0114613 A1
(43) Pub. Date: May 19, 2011

(54) COMPACT WELDING WIRE FEEDER

(75) Inventors: Jeffery Ray Ihde, Greenville, WI (US); Joesph Kyle Fink, Black Creek, WI (US); Thomas Don Lahti, Appleton, WI (US); James Lee Uecker, Appleton, WI (US); Richard Martin Hutchison, Iola, WI (US); Michael Todd Klegin, Greenville, WI (US); Gary Allen Thyssen, Appleton, WI (US)

(73) Assignee: Illinois Tool Works Inc., Glenview, IL (US)

(21) Appl. No.: 12/881,890

(22) Filed: Sep. 14, 2010

Related U.S. Application Data
(60) Provisional application No. 61/262,014, filed on Nov. 17, 2009.

(51) Int. Cl. B23K 9/28; B65H 49/34

(52) U.S. Cl. 219/136; 219/137.2; 242/564

(57) ABSTRACT

Embodiments of a welding system include a compact wire feeder adapted to feed welding wire having a diameter up to approximately 5/64 inches disposed on a wire spool having an outer diameter of approximately 8 inches. The compact wire feeder may include a housing, a spool mounting hub disposed in the housing and adapted to receive the wire spool, and a wire drive assembly having a motor adapted to apply an output torque to a shaft of a gearbox to drive the welding wire from the welding spool to a welding torch.

### CROSS REFERENCE TO RELATED APPLICATIONS

This application is a Non-Provisional patent application of U.S. Provisional Patent Application No. 61/262,014 entitled “Welding Wire Delivery System”, filed Nov. 17, 2009, which is herein incorporated by reference.

### BACKGROUND

The invention relates generally to the field of wire feeders and/or welding systems. More specifically, the invention relates to a welding wire feeder.

In certain applications, a welding wire feeder may be used to feed a welding wire through a torch to a weld location in front of the tip of the torch. In many applications, it may be desirable to move the wire feeder to a remote location or simply to a different location in a work area. Otherwise, the wire feeder may be required to drive the wire over an unnecessarily long run of conduit to the particular work location. As a result, the wire feeder may require a more robust and expensive drive mechanism.

Unfortunately, many conventional wire feeders are designed as stationary devices intended to remain within a particular work area. However, some “suitcase” wire feeders are currently available, and are specifically designed to enable a user to carry the wire feeders to the desired location. Unfortunately, due to size and weight constraints of such suitcase wire feeders, they are traditionally capable of only feeding wires of small diameters (e.g., up to approximately 1/16″). In some welding applications, large diameter wires may be desired for the given welding operation, and the weld location may necessitate the use of a portable or suitcase wire feeder. Accordingly, there exists a need for portable wire feeders capable of feeding larger diameter wires.

### BRIEF DESCRIPTION

In an exemplary embodiment, a compact wire feeder includes a housing and a spool mounting hub disposed in the housing and adapted to receive a wire spool having an outer diameter equal to approximately 8 inches and wire with a diameter of approximately 5/64″ disposed thereon. The compact wire feeder also includes a wire drive assembly disposed in the housing and adapted to receive the 5/64″ wire from the wire spool and to drive the 5/64″ wire to a welding torch. The wire drive assembly includes a motor adapted to output a torque on a shaft of a gearbox sufficient to drive the 5/64″ wire to the welding torch.

In another embodiment, a welding system includes a compact wire feeder adapted to feed welding wire having a diameter up to approximately 5/64″ disposed on a wire spool having an outer diameter of approximately 8 inches. The compact wire feeder includes a housing and a spool mounting hub disposed in the housing and adapted to receive the wire spool. The compact wire feeder also includes a wire drive assembly including a motor configured to apply an output torque to a shaft of a gearbox to drive the welding wire from the welding spool to a welding torch.

In another embodiment, a compact wire feeder includes a housing and a spool mounting hub disposed in the housing and adapted to receive a wire spool having an outer diameter of approximately 8 inches. The compact wire feeder also includes a wire drive assembly including a motor and a gearbox having a shaft. The motor is adapted to output a torque on the shaft sufficient to drive a 5/64″ wire from the wire spool to the welding torch.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an exemplary compact wire feeder in accordance with aspects of the present invention;

FIG. 2 illustrates the compact wire feeder of FIG. 1 with a side panel removed to expose a spool mounting hub and a wire drive assembly disposed therein in accordance with aspects of the present invention;

FIG. 3 is an exploded view of an exemplary wire drive mechanism that may be disposed in embodiments of the compact wire feeder;

FIG. 4 is a perspective view of an exemplary wire spool in accordance with aspects of the present invention; and

FIG. 5 is a front view of the wire spool of FIG. 4 in accordance with embodiments of the present invention.

### DETAILED DESCRIPTION

As described in detail below, embodiments of a compact welding wire feeder are provided. Embodiments of the compact welding wire feeder may include a motor with an increased output torque equal to approximately 50 in-lbs when operated with a spool having an outside diameter of approximately 8 inches, as compared to traditional systems, which may be capable of approximately 25 in-lbs of output torque when operated with a welding wire spool of a comparable size. Such a torque increase, as compared to traditional systems, may be facilitated by embodiments of the present invention because some embodiments of the motor may utilize synthetic oil instead of grease for gear lubrication. Accordingly, embodiments of the presently disclosed compact welding wire feeder may include motors with increased motor efficiency as compared to current designs.

The compact welding wire feeder may be configured to receive welding wire spools with an inner diameter equal to approximately 5 inches, an outer diameter equal to approximately 8 inches, and a spool width equal to approximately 3.2 inches. Such welding wire spools may be adapted to receive wire with diameters up to approximately 5/64″. Such features of the presently disclosed welding wire spools may result in a reduced stack height of the welding wire disposed thereon, thus generating a substantially consistent motor output torque. The foregoing features may also reduce the wire cast, thereby improving contact between the wire and the contact tip of the welding torch as compared to traditional systems. Such improvements in the components of the compact welding wire feeder may provide advantages over current designs by allowing for a decrease in wire cast accompanied by an increase in motor output torque while maintaining the reduced package size of current designs.

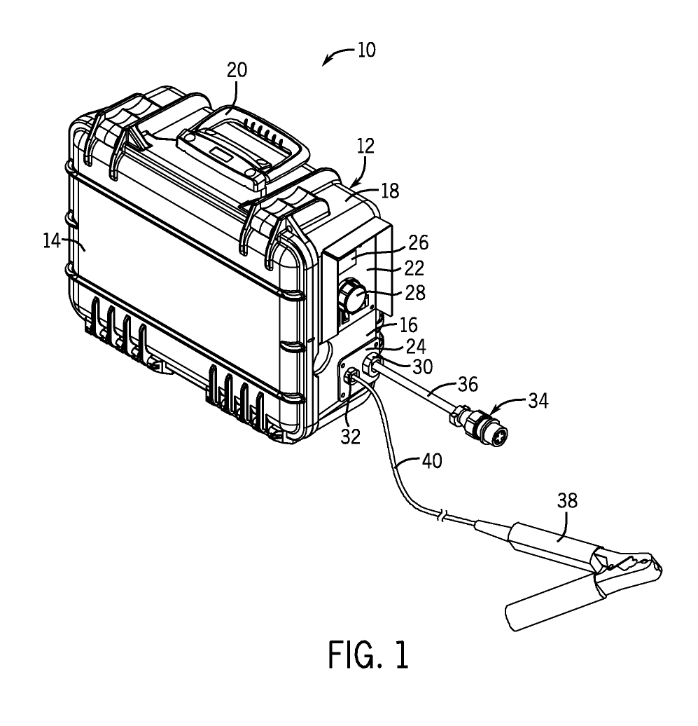

Turning now to the drawings, FIG. 1 illustrates a compact wire feeder 10 that is configured to provide welding wire for a welding operation. In some embodiments, the compact wire feeder 10 may be a suitcase wire feeder configured for use in welding applications that require a portable wire feeder. For example, such suitcase wire feeders may be utilized in applications where the weight and size of the wire feeder are constrained by environmental factors, such as in shipbuilding applications. For further example, such suitcase wire feeders may be capable of being moved from one location to another by a human user without the use of tools, machines, or vehicles. Whereas traditional portable wire feeders may limit the maximum allowable wire diameter size to approximately 1/16″, the presently disclosed compact wire feeders retain the aforementioned portability while allowing for feeds of wire diameters up to approximately 5/64″ in diameter.

In the illustrated embodiment, the compact wire feeder 10 includes a housing 12 with a side panel 14, a front panel 16, and a top panel 18. The top panel 18 includes a handle 20, which allows a welding operator to move the portable wire feeder 10 from one location to another without the use of a tool, machine, or vehicle. Such a feature may allow the operator to position the portable wire feeder as desired in welding environments that may not be accessible to larger vehicles or transportation tools. The front panel 16 of the compact wire feeder 10 includes a control panel 22 and an electrical panel 24.

The illustrated control panel 22 includes meters 26, such as a voltmeter and a wire speed/amperage meter, and a wire feed speed adjustment knob 28. The voltmeter is configured to display the arc voltage during a weld and to display the open circuit voltage during idling. The wire speed/amperage meter is configured to display wire feed speed and amperage during the welding process. The wire feed speed adjustment knob 28 may be rotated by the operator to adjust the speed of the wire exiting the wire feeder. The control panel 22 may include additional switches, meters, knobs, and so forth, or fewer of such components, as desired for the given application. For example, in some embodiments, the wire feeder 10 may also include a jog/purge switch configured to allow an operator to jog wire without energizing the contactor or gas valve, a trigger hold switch configured to allow the operator to weld without holding a welding gun trigger, a power switch configured to allow the operator to turn the unit ON or OFF, and so forth.

The illustrated electrical panel 24 includes a first electrical connection 30 and a second electrical connection 32. In the illustrated embodiment, the first electrical connection 24 couples to a gun trigger receptacle 34 via cable 36, and the second electrical connection 32 couples to a ground clamp 38 via cable 40. The gun trigger receptacle 34 is further adapted to mate with a gun trigger plug coupled to a welding torch. As such, the gun trigger receptacle 34 is configured to couple to a variety of welding guns suitable for use in a variety of welding processes, such as metal inert gas welding (MIG) or any other welding process that utilizes a wire feed.

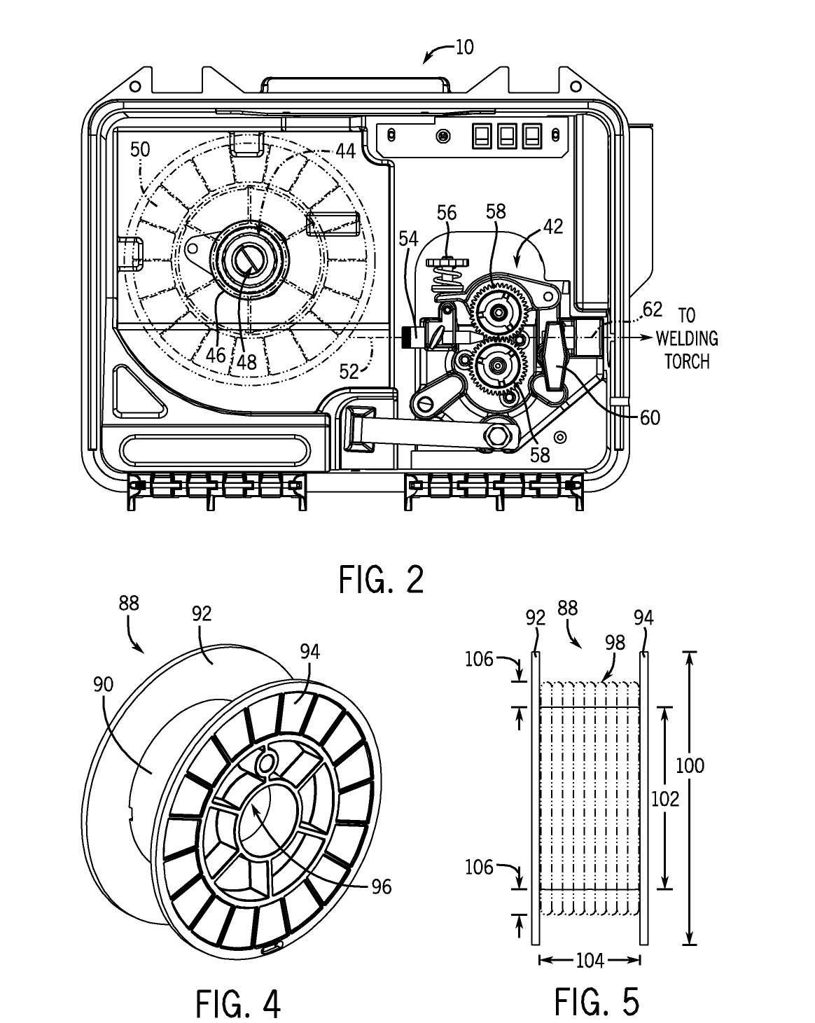

FIG. 2 illustrates a side view of the compact wire feeder 10 of FIG. 1 with the side panel 14 removed, thus exposing internal components of the wire feeder. As shown, the wire feeder 10 includes a wire drive assembly 42 and a spool mounting hub 44. The spool mounting hub 44 includes a retaining nut 46 and a hub tension adjustment knob 48. During use, a retaining ring is removed from the hub 44, a wire spool is installed such that a hub pin is received by the spool hole, and the retaining nut 46 is reinstalled. The hub tension adjustment knob 48 is manually adjusted to apply a slight force to turn the wire spool 50.

Wire 52 from the wire spool 50 is fed through the wire drive assembly 42 to the welding torch. As such, the wire drive assembly 42 is configured to receive the welding wire 52 and feed the wire to the welding torch. Accordingly, the wire drive assembly 42 includes an inlet 54, a pressure assembly adjustment knob 56, a set of drive rollers 58, a securement knob 60, and an outlet 62. During use, the wire 52 is gripped between the drive rollers 58, which rotate to establish and maintain a wire feed from the inlet 54 to the outlet 62. As described in detail below, the wire 52 may have a diameter up to approximately 5/64″, thus offering an advantage over traditional portable wire feeders, which are capable of feeding wires with diameters up to approximately 1/16″. Additionally, the weight of the wire spool 50 may be reduced as compared to traditional systems (e.g., from approximately 15 lbs to approximately 10 lbs), thus reducing the weight of the compact wire feeder 10 and increasing the portability of the system.

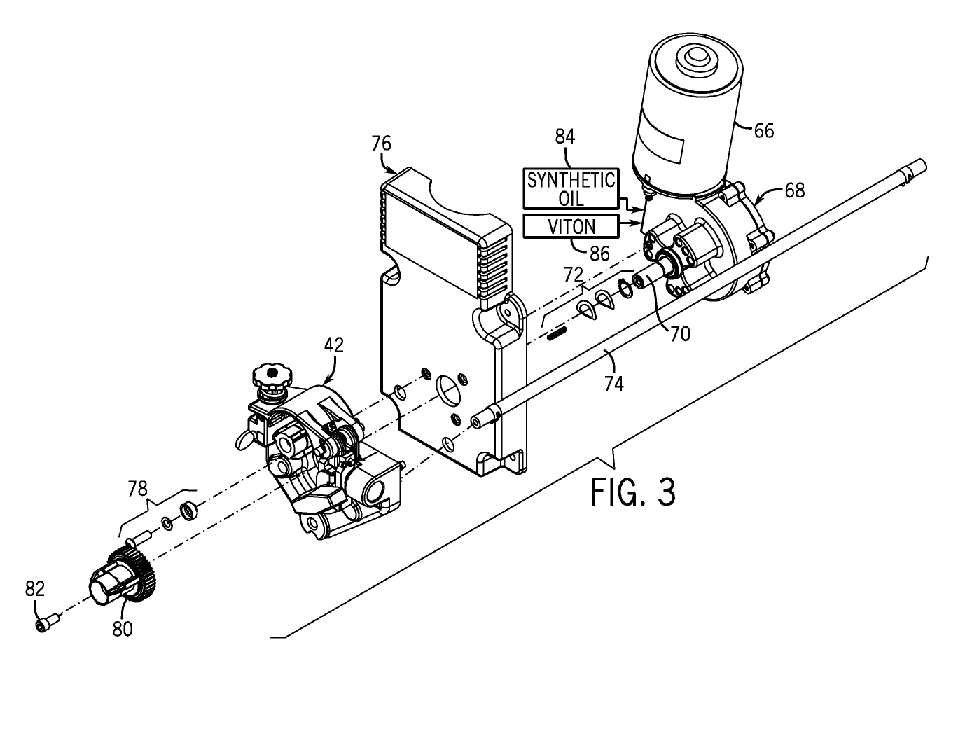

FIG. 3 is an exploded view illustrating an exemplary drive mechanism of the compact wire feeder 10 of FIGS. 1 and 2. In the illustrated embodiment, the drive mechanism for the compact wire feeder 10 includes a power cable (not shown), a motor 66, a gearbox 68, a shaft 70, mechanical components 72, a gas hose 74, a mounting plate 76, the wire drive assembly 42, mechanical components 78, a drive roll carrier 80, and a securement member 82. When assembled, the motor 66 mounts to the gearbox 68, which bolts to the mounting plate 76, which bolts to the casting of the wire drive assembly 42. In some embodiments, the motor 66 may be a permanent magnetic direct current (DC) motor. In other embodiments, the motor 66 may be a DC brushless motor or any other suitable motor type.

As shown, synthetic oil 84 may be utilized to lubricate the gears in the gearbox 68, and Viton® 86 may be utilized as the gearbox seal. It should be noted that although Viton® 86 is utilized in the illustrated embodiment, any suitable type of synthetic rubber may be utilized in other embodiments. The foregoing features may offer distinct advantages over traditional compact wire feeders because the synthetic oil 84 may increase efficiency of the motor 66 as compared to motors utilizing a grease lubricant, thereby resulting in an increase in output torque of the motor 66 when in use. For example, in one embodiment, the output torque of the motor 66 may be approximately 50 in-lbs when an 8″ outer diameter wire spool is installed, as compared to an approximately 25 in-lbs output motor torque for a wire spool with an 8″ diameter in traditional systems. That is, embodiments of the present invention may allow for an increased torque on the output shaft 70 of the gearbox 68 while maintaining the compact size of the wire feeder unit. As such, when coupled to an appropriate wire spool, as described in detail below, the compact wire feeder disclosed herein may facilitate the delivery of wire with a larger diameter than traditional compact systems.

FIGS. 4 and 5 illustrate an exemplary wire spool 88 that may be mounted within the compact wire feeder 10 to supply a welding gun with wire for a welding operation. Specifically, FIG. 4 illustrates a perspective view of the wire spool 88, and FIG. 5 illustrates a front view of the wire spool 88. As shown, the wire spool 88 includes a hub 90 disposed between a first side plate 92 and a second side plate 94. The side plates 92 and 94 include an opening 96 appropriately sized and shaped to receive the spool mounting hub 44 when installed in the compact wire feeder 10. Wire 98 is mounted on the hub 90 and is configured to be unwound from the wire spool 88 for use in the welding operation.

The wire spool 88 is defined by an outer diameter 100, as defined by a diameter of the side plates 92 and 94, an inner diameter 102, as defined by an outer diameter of the hub 90, and a spool width 104. A stack height 106 of the wire 98 disposed on the hub 90 defines the amount by which the wire 98 extends above the hub 90 when wound thereon. A variety of features of the wire spool 88 and the wire 98 disposed thereon may provide advantages over traditional wire spools configured for mounting in compact wire feeders. For example, the wire 98 may have a diameter up to approximately 5/64″, as compared to traditional systems that are capable of feeding wire with diameters up to only 1/16″. To enable the compact feeder 10 to be capable of feeding wires of such diameters while maintaining the compact overall package size, the wire spool 88 may be advantageously designed to accommodate such wire diameters. Further, control of the wire feeding process may be optimized for accuracy at low speeds when feeding larger diameter wires. For example, embodiments of the present invention may provide for the wire drive assembly to drive the wire within a low speed range between approximately 25 ipm and approximately 200 ipm and/or to drive the wire within a high speed range between approximately 175 ipm and approximately 800 ipm.

In one embodiment, the outer diameter 100 of the wire spool 88 may be approximately 8″, the inner diameter 102 may be approximately 5″, and the spool width may be approximately 3.2″. As such, the ratio of the outer diameter to the inner diameter of the wire spool 88 may be 8/5. In such an embodiment, the weight of the wire spool 88 with the welding wire 98 mounted thereon may be approximately 10 lbs, as compared to traditional 15 lbs systems. Since traditional wire spools designed for mounting in compact wire feeders may have an outer diameter of approximately 8″, an inner diameter of approximately 4″, and a spool width of approximately 2.8″, such an embodiment may offer distinct advantages that allow for feeding of wires with increased diameters.

For example, by increasing the spool width 104 and the inner diameter 102 while maintaining the outer diameter 100 constant, the wire cast and the stack height 106 may be reduced. Thus, the required motor output torque may remain substantially consistent throughout the wire feeding process. Additionally, the reduced stack height 106 resulting in the reduced wire cast may offer benefits over traditional compact wire feeders. For example, by limiting the wire cast, system downtime may be reduced or eliminated because the motor current draw is reduced. Reducing the wire cast may also improve weld quality because the wire may be more precisely delivered to the weld puddle. The foregoing features may facilitate the feeding of wires with increased diameters from portable, compact wire feeder units that are traditionally limited in application by small diameter wires.

It should be noted that the previously described features of the wire drive assembly and the wire spool may be coupled together in some embodiments to provide a compact, portable wire feeder capable of producing substantially higher motor output torques that support feeding of wires with increased diameters up to approximately 5/64″. For example, although the increased diameter size increases the torque requirements on the motor, the reduction in stack height of the wire achieved by resizing parameters of the wire spool may lead to more consistent torque requirements. As such, the increased torque requirements may be met by the motor by lubricating the gears in the gearbox with synthetic oil, sealing the gearbox with Viton®, and so forth.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A compact wire feeder, comprising:
a housing;
a spool mounting hub disposed in the housing and configured to receive a wire spool having an outer diameter equal to approximately 8 inches and wire with a diameter of approximately 5/64″ disposed thereon;
a wire drive assembly disposed in the housing and configured to receive the 5/64″ wire from the wire spool and to drive the 5/64″ wire to a welding torch, wherein the wire drive assembly comprises a motor configured to output a torque on a shaft of a gearbox sufficient to drive the 5/64″ wire to the welding torch.

2. The compact wire feeder of claim 1, wherein the torque on the shaft is equal to approximately 50 in-lbs.

3. The compact wire feeder of claim 1, wherein the gearbox is lubricated with synthetic oil.

4. The compact wire feeder of claim 1, wherein the inner diameter of the wire spool is approximately 5 inches.

5. The compact wire feeder of claim 1, wherein the width of the wire spool is approximately 3.2 inches.

6. The compact wire feeder of claim 1, wherein the weight of the wire spool with the 5/64″ wire disposed thereon is approximately 10 lbs.

7. The compact wire feeder of claim 1, wherein a synthetic rubber is utilized to seal the gearbox.

8. A welding system, comprising:
a compact wire feeder configured to feed welding wire having a diameter up to approximately 5/64″ disposed on a wire spool having an outer diameter of approximately 8″, comprising:
a housing;
a spool mounting hub disposed in the housing and configured to receive the wire spool; and
a wire drive assembly comprising a motor configured to apply an output torque to a shaft of a gearbox to drive the welding wire from the welding spool to a welding torch.

9. The welding system of claim 8, wherein the wire spool comprises an inner diameter of approximately 5″ and a width of approximately 3.2″.

10. The welding system of claim 9, wherein the combination of the wire spool and the wire weighs approximately 10 lbs.

11. The welding system of claim 8, wherein the gearbox is lubricated with synthetic oil and sealed with a synthetic rubber.

12. The welding system of claim 8, wherein the output torque is equal to approximately 50 in-lbs.

13. The welding system of claim 8, wherein the compact wire feeder is a suitcase wire feeder configured for transport from one location to another by a welding operator without the use of a tool, machine, or vehicle.

14. A compact wire feeder, comprising:
a housing;
a spool mounting hub disposed in the housing and configured to receive a wire spool having an outer diameter of approximately 8 inches;
a wire drive assembly comprising a motor and a gearbox having a shaft, wherein the motor is configured to output a torque on the shaft sufficient to drive a 5/64″ wire from the wire spool to the welding torch.

15. The compact wire feeder of claim 14, wherein the compact wire feeder is a suitcase wire feeder configured to be transported from one location to another via carrying by a welding operator.

16. The compact wire feeder of claim 14, wherein a ratio of the outer diameter to the inner diameter of the wire spool is approximately 8/5.

17. The compact wire feeder of claim 16, wherein the width of the wire spool is approximately 3.2 inches.

18. The compact wire feeder of claim 14, wherein the wire drive assembly further comprises drive rollers configured to rotate to drive the wire from the wire spool to the welding torch.

19. The compact wire feeder of claim 14, wherein the torque is equal to approximately 50 in-lbs.

20. The compact wire feeder of claim 14, wherein the wire drive assembly is configured to drive the wire within a low speed range between approximately 25-200 ipm and/or to drive the wire within a high speed range between approximately 175-800 ipm.
